(19) United States
(12) Patent Application Publication
(10) Pub. No.: US 2005/0281028 A1
(43) Pub. Date: Dec. 22, 2005

(54) Count-down-to-christmas-scene-device

(76) Inventor: Frank C. Orsini, Hoboken, NJ (US)

Correspondence Address: FRANK C. ORSINI, 103 4th St. # 2, Hoboken, NJ, 07030, US

(21) Appl. No.: 10/872,081

(22) Filed: Jun. 18, 2004

(51) Int. Cl. F21V 33/00

(52) U.S. Cl. 362/234

(57) ABSTRACT

The “Count-Down-to-Christmas-Scene-Device” is a battery operated (or cord plug-in) Christmas Scene designed to technically count down the “Twelve Days TO Christmas” (12, 11, 10, 9, 8, 7, 6, 5, 4, 3, 2, 1, “Merry Christmas!!”. The concept is an electrical countdown using numbered Christmas Lights (or the numbers are displayed counting down on an LCD screen) somewhere in a Christmas Scene/design” (on a tree beside a house, on the house—as in lights decorated on the roof or lawn, on a pole or “North Pole”, etc). Each numbered Christmas Light will light up according to the number of days left till Christmas. The numbered Christmas Lights are tied to a “TIMER”, which is tied to the Atomic Clock for perfect time or a “pre-set” clock timer. This will enable the “Count-Down-to-Christmas-Scene-Device” to work perfectly. The “Count-Down-to-Christmas-Scene-Device” may/can also play Christmas songs.

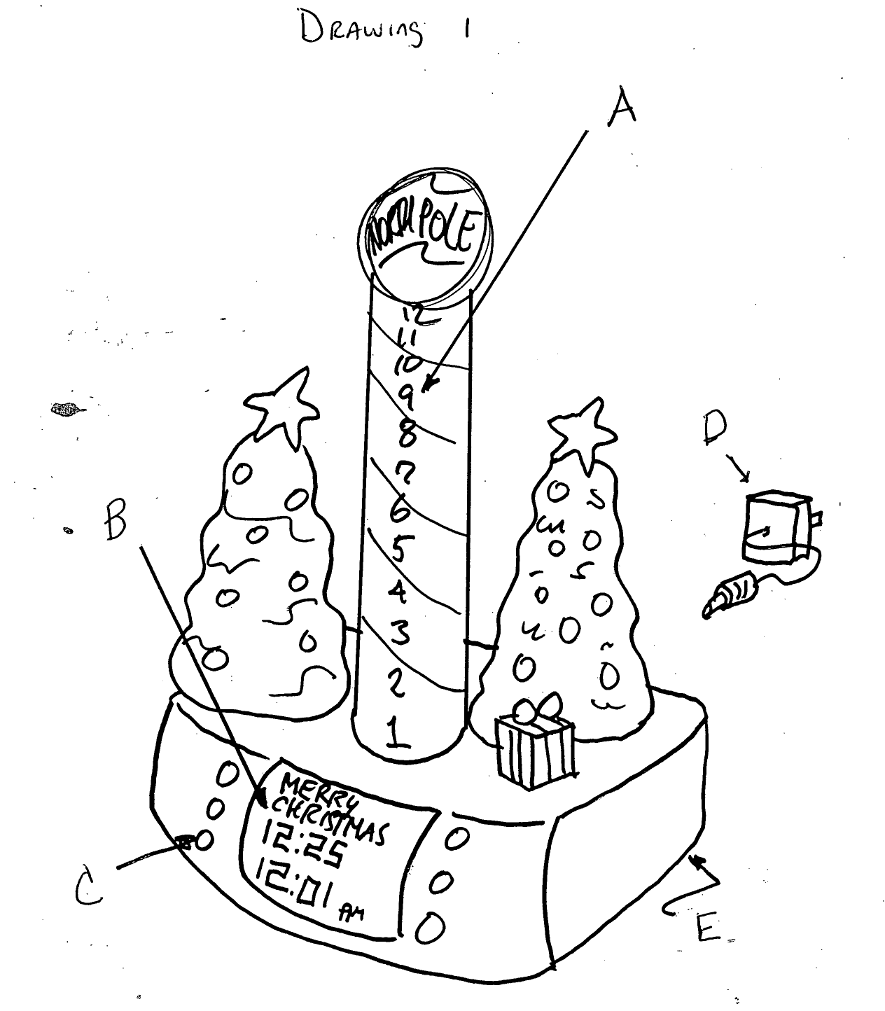

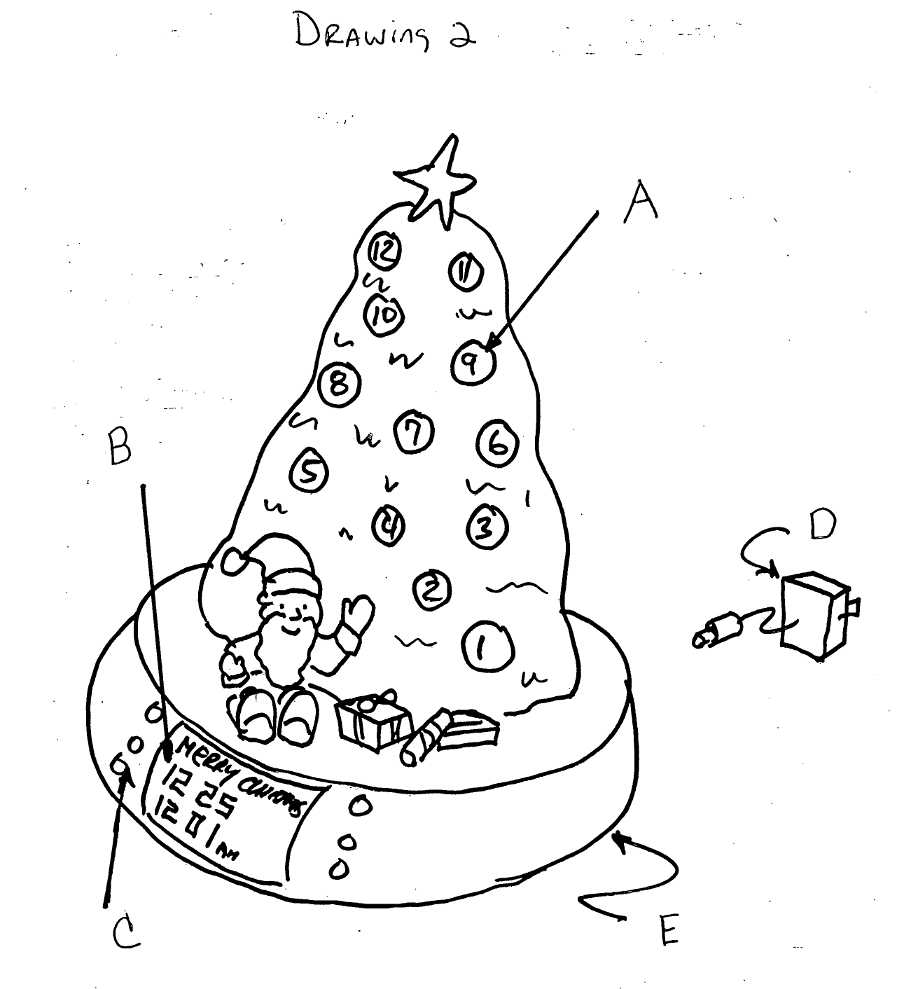

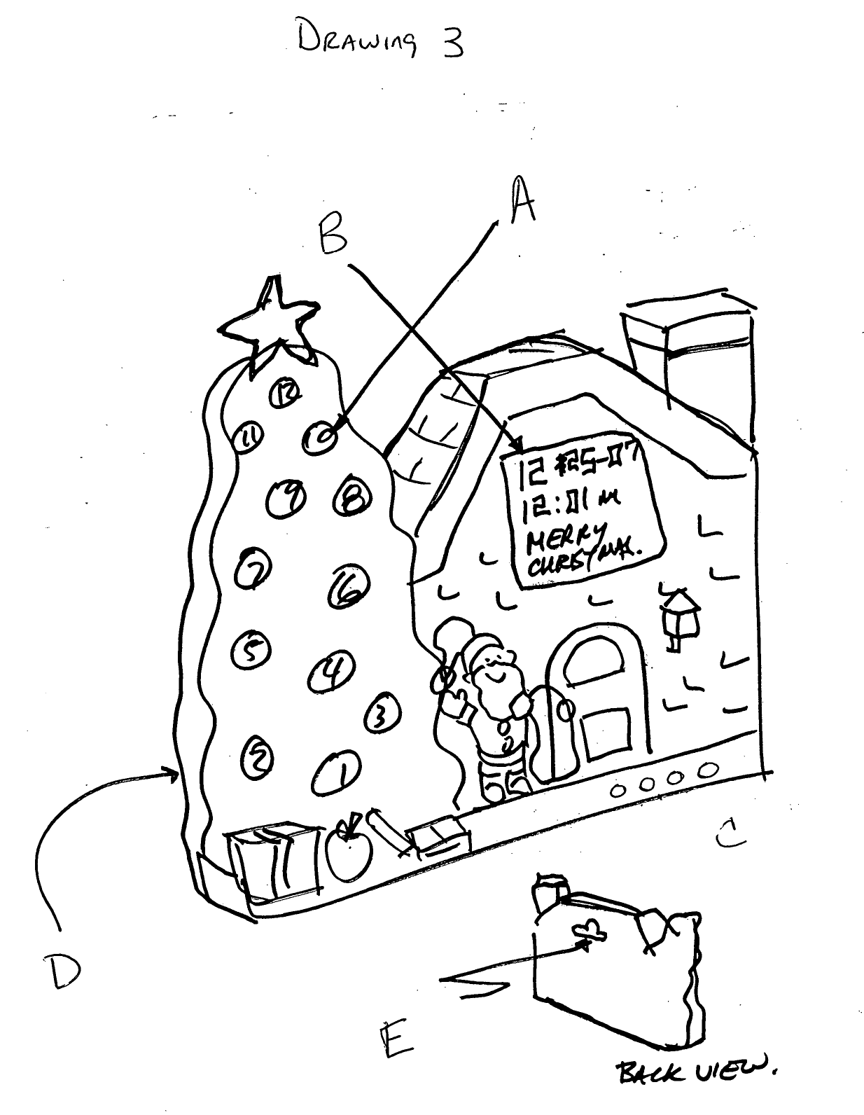

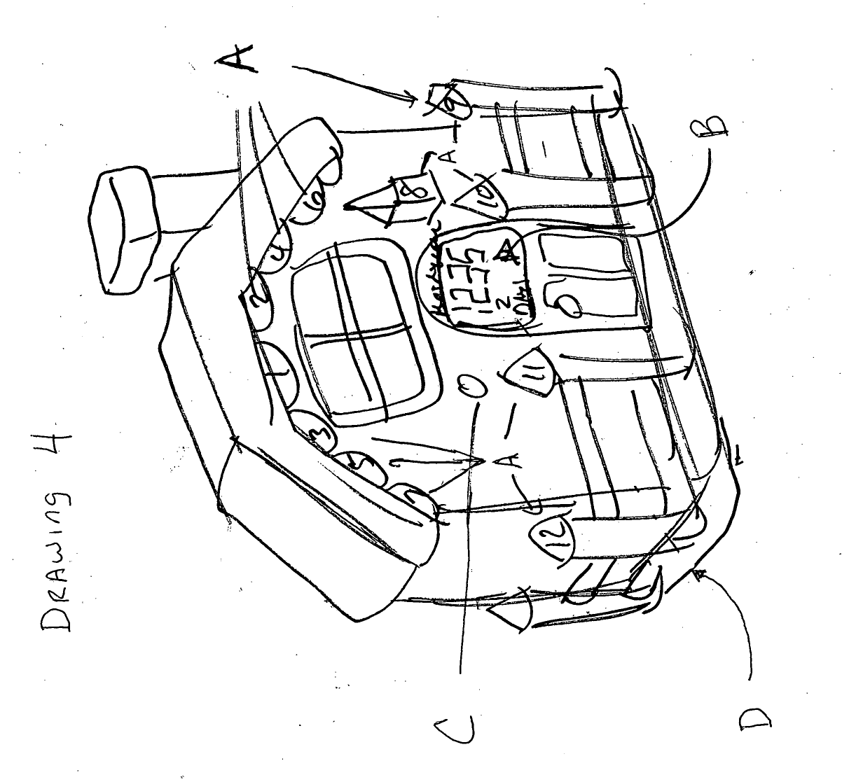

### FIELD and BACKGROUND OF INVENTION

There are many December devices/calendars (December 1-31) to anticipate Christmas day, December 25th, as well as other events during the year: New Years Eve, birthdays, Easter, etc.

Put simply, this invention was thought of as a way for children and adults alike as a way to enhance their anticipation of the arrival on Christmas with lights and flair. There are many “calendars” out there for the month of December, but nothing that specifically counts down the “12 days TO Christmas”.

Some devices/calendars have “pop-out” windows/boxes which reveal a treat or a story. Some use candy. Some are configured with the standard columns and rows like a regular calendar. Some have individual pieces to mark the days or numbers and yet some are blank for individuals to mark the days themselves.

The 12 Days before Christmas during the Christmas season represent and always mark the “highest” time of anticipation to Christmas day. As you will see, the “Countdown-to-Christmas-Scene-Device” is a new and improved CHRISTMAS HOLIDAY anticipation product and far superior to the prior art of holiday calendars. Further, all prior art is based on manual participation of a person (open set squares, write on a board, move pieces or objects). The Count-Down-to-Christmas-Scene-Device uses modern technology, is electrical (plug-in or battery operated) has lights and uses a pre-set or the atomic clock.

U.S. Pat. No. 6,581,310—Jun. 24, 2003, (Holiday Countdown) consists of fabric with ribbons that attach to it marking the days to which any holiday, birthday or special event is coming up. The elongated fabric also comprises spaces for all days of December, as well all months for the purpose of marking any holiday, birthday or special event. The ribbons are also tied to a treat or plush toy.

U.S. Pat. No. 4,975,061—Dec. 4, 1990 (Child's Holiday Calendar). This uses a calendar matrix, along with candy and visual markers. It is also specifically for children prior to their ability to read.

U.S. Pat. No. 5,058,296—Oct. 22, 1991 (Calendar). This is an Advent calendar with “steps” that an individual moves a “piece” along the pathway marking each day. It also has spaces for “gifts” at certain days.

U.S. Pat. No. 5,257,940—Nov. 2, 1993. (Child's educational Calendar). This invention has columns and rows that relate to a normal calendar, and is intended to help children understand “days” and “weeks”.

U.S. Pat. No. 5,813,539—Sep. 29, 1998. (Calendar Organizer). This invention is for identifying important events, holidays, vacations, bill payments, etc.

### SUMMERY OF INVENTION

Undoubtedly, you can picture what was previously stated and the uniqueness of the product; however, in summery, the Count-Down-to-Christmas-Scene-Device uses modern technology to count down the 12 days TO Christmas like no other product.

The prior art is made of paper or another form of fabric, has spaces for all or a portion of the days of a month. But most off all, they don't single out the 12 days TO Christmas. Non, not Patent# 6,581,310 or 4,975,061 or 5,058,296 or 5,257,940 or 5,813,539. Combined with the use of LED's or LCD's, this product separates itself from all other prior products and stands alone in counting down the 12 days TO Christmas. This invention is for the enjoyment of adults, children and families to enjoy the Christmas Holiday.

### BRIEF DESCRIPTION OF DRAWINGS

Drawing 1:

Is an illustration of a “Count-Down-to-Christmas-Scene-Device” in which the Christmas Scene is a scene of the “North Pole”, where the numbered lights are on the North Pole and will light up (using LED's) and count down 12, 11, 10, 9, 8, 7, 6, 5, 4, 3, 2, 1- to “Merry Christmas”.

As Referenced:

A=Numbered lights from 12 to 1 using LED's.
B=LCD clock window using the Atomic or pre-set clock timer. “Merry Christmas” is included in the LCD window.
C=Set function buttons (play Christmas songs, etc).
D=A/C adaptor
E=Battery compartment in base.
   Drawing 2:

Is an illustration of a “Count-Down-to-Christmas-Scene-Device” in which the Christmas Scene is a scene of a Christmas Tree with Christmas toys and Santa, where the numbered lights are on the Christmas Tree. The lights will light up (using LED's) and count down 12, 11, 10, 9, 8, 7, 6, 5, 4, 3, 2, 1- to “Merry Christmas”.

As Referenced:

A=Numbered lights from 12 to 1 using LED's which will light up according to the number of days left till Christmas.
B=LCD clock window using the Atomic or pre-set clock timer. “Merry Christmas” is included in the LCD window.
C=Set function buttons (play Christmas songs, etc).
D=A/C adaptor
E=Battery compartment in base.
   Drawing 3:

Is an illustration of a “Count-Down-to-Christmas-Scene-Device” to mount on wall in which the Christmas Scene is a scene of a home, Christmas Tree with Christmas toys and Santa, where the numbered lights are on the Christmas Tree. The lights will light up (using LED's) and count down 12, 11, 10, 9, 8, 7, 6, 5, 4, 3, 2, 1- to “Merry Christmas”.

As Referenced:

A=Numbered lights from 12 to 1 using LED's which will light up according to the number of days left till Christmas.
B=LCD clock window using the Atomic or pre-set clock timer. “Merry Christmas” is included in the LCD window.
C=Set function buttons (play Christmas songs, etc).
D=A/C adaptor or battery compartment.
E=Recess or clip on Back to mount on wall.
   Drawing 4:

Is an illustration of a “Count-Down-to-Christmas-Scene-Device” in which the Christmas Scene is a Christmas decorated home, where the numbered lights are on the roof and fence and LDC screen is above the door. The lights will light up (using LED's) and count down 12, 11, 10, 9, 8, 7, 6, 5, 4, 3, 2, 1- to “Merry Christmas”.

As Referenced:

A=Numbered lights from 12 to 1 using LED's which will light up according to the number of days left till Christmas.
B=LCD clock window using the Atomic or pre-set clock timer. “Merry Christmas” is included in the LCD window.
C=Set function buttons (play Christmas songs, etc).
D=A/C adaptor or battery compartment.

1. A “Count-down-to-Christmas-Scene-Device comprising a Christmas scene in which Lights numbered 12, 11, 10, 9, 8, 7, 6, 5, 4, 3, 2, 1 are lit up in accordance to the number of days left till Christmas Day (December 25).

2. A “Count-Down-to-Christmas-Scene-Device” as stated in claim 1, where “Merry Christmas!!” is lit up after the light numbered “1” turns off.

3. A “Count-Down-to-Christmas-Scene-Device” as stated in claim 1, that is either tied to the Atomic Clock, Atomic Clock timer or Pre-set Timer.

4. A “Count-Down-to-Christmas-Scene-Device” as stated in claim 1, where an LCD screen is used to count down the days till Christmas from 12 to 1 and/or say “Merry Christmas”.

5. A “Count-Down-to-Christmas-Scene-Device” as stated in claim 1, where LED's are used to light up the lights to identify the 12-day count down to Christmas.

6. A “Count-Down-to-Christmas-Scene-Device” as stated in claim 1, that either hangs on the wall or is a fixture on a platform.

7. A “Count-Down-to-Christmas-Scene-Device” as stated in claim 1, that may play Christmas songs as part of its function.
